(19) United States
(12) Patent Application Publication
(10) Pub. No.: US 2014/0186813 A1
(43) Pub. Date: Jul. 3, 2014

(54) ACADEMIA INDUSTRY INTERFACE FRAMEWORK

(71) Applicant: TATA CONSULTANCY SERVICES LIMITED, Mumbai (IN)

(72) Inventor: Rajiv Noronha, Bangalore (IN)

(73) Assignee: TATA CONSULTANCY SERVICES LIMITED, Mumbai (IN)

(21) Appl. No.: 13/731,621

(22) Filed: Dec. 31, 2012

(51) Int. Cl. G09B 5/08

(52) U.S. Cl. CPC G09B 5/08
USPC 434/350

(57) ABSTRACT

The present subject matter relates to an academia industry interface framework. The method includes receiving collaboration instructions from an industrial organization. The method further comprises defining a plurality of collaboration parameters based on the collaboration instructions. The collaboration parameters comprise at least one of communication parameters, leadership influence parameters, influencing curriculum parameters, faculty influence parameters, and student influence parameters. Further, the method initiates the communication between the industrial organization and different sections of an academic institution in a predefined sequence based on the collaboration parameters.

### TECHNICAL FIELD

The present subject matter, in general, relates to academia-industry interfacing and, in particular, relates to method(s) and system(s) for implementing an academia industry interface framework.

### BACKGROUND

Various industries rely on academic institutions for efficient supply of talented human resources. Similarly, academic institutions rely on the industries for ensuring a good career path for their students. Therefore, failure to recognize each other's role will reduce the effectiveness of the interface between the academic institution and industry; and it can potentially give rise to mismatch between demand and supply of talented human resources, which, in turn, can cause disruption in the job market. With increasing awareness, academic institutions, and industries are rapidly inching closer to each other to create synergies. Subsequently, various academic interface programs are being developed in order to establish productive and efficient interaction between academic world and industries.

The conventional academic interface programs allow students of the academic institutions to make an informed and conscious decision for choosing their career path. Such conventional academic interface programs consider various factors, such as the curriculum and the cooperation of the faculty, independent from each other, for facilitating the choice of career. Such conventional programs

### SUMMARY

This summary is provided to introduce concepts related to an academia industry interface framework, and the concepts are further described below in the detailed description. This summary is not intended to identify essential features of the claimed subject matter nor is it intended for use in determining or limiting the scope of the claimed subject matter.

In one implementation, the present subject matter relates to a computer implemented method for implementation of an academia industry interface framework. The method includes receiving collaboration instructions from an industrial organization. The method further comprises defining a plurality of collaboration parameters based on the collaboration instructions. The collaboration parameters comprise at least one of communication parameters, leadership influence parameters, influencing curriculum parameters, faculty influence parameters, and student influence parameters. Further, the method initiates communication between the industrial organization and different sections of an academic institution in a predefined sequence based on the collaboration parameters.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1(a) illustrates a network environment implementing an academia industry interface system, in accordance with an embodiment of the present subject matter.

FIG. 1(b) illustrates a representation of an academia industry interface framework, in accordance with an embodiment of the present subject matter.

FIG. 2 illustrates a method for implementing an academia industry interface framework, in accordance with an embodiment of the present subject matter.

### DETAILED DESCRIPTION

System(s) and method(s) for implementing an academia industry interface framework are provided. The system(s) and method(s) can be implemented in a variety of computing devices, such as laptops, desktops, workstations, tablet-PCs, notebooks, portable computers, tablet computers, internet appliances, and similar systems. However, a person skilled in the art will comprehend that the embodiments of the present subject matter are not limited to any particular computing system, architecture or application device, as they may be adapted to take advantage of new computing systems and platforms as they become available.

Generally, human resources, such as skilled manpower play a substantial role in growth and development of an industrial organization. Industrial organizations from different fields prefer human resources with skills appropriate for their industrial organization. For example, an industrial organization belonging to the chemical industry may opt for human resources with primary skills in field of chemical engineering or chemistry, whereas, another industrial organization belonging to the mechanical industry prefers mechanical engineering skills. Further, for good quality and talented human resources, the industrial organizations are hugely dependent on academic institutions, such as universities and colleges. As would be understood, the academic institutions may play a major role in training students for developing skills pertinent to a specific industry.

On the other hand, the academic institutions aim to provide attractive and relevant career opportunities to students. Better placement records of the students build prominent stature and gain recognition for the academic institution and encourage more students to join the academic institution, thereby providing significant growth opportunities to the academic institution. Further, the academic institutions rely on the industrial organizations from different fields to offer good career path to their students. Therefore, academic institutions and industrial organizations are mutually dependent for their growth and development.

Consequently, academic institutions and industrial organizations from different fields collaborate with each other. To ensure a productive interaction between industrial organizations and the academic institutions, various academia industry interface frameworks have been developed. Generally, the existing academia industry interface frameworks address elements, such as curriculum, academic leaders or administrative personnel, faculty, and students. However, the existing academia industry interface frameworks approach the elements in a fragmented manner, i.e., the elements are addressed independently and there is a lack of interaction between stakeholders, such as the students, the faculty, and the administrative personnel. In addition, lack of communication adds to the fragmented approach of existing academia industry interface frameworks. Therefore, the existing academia industry interface framework works in an unstructured and disjointed manner.

In addition to that, the existing academia industry interface frameworks may not address the interaction between the industrial organizations and the academic institutions from a business perspective. Therefore, the conventional academia industry interface frameworks lack a structured and integrated manner for effective, holistic, and comprehensive interaction between academic institutions and industrial organizations.

According to the present subject matter, an academia industry interface system, hereinafter referred to as system, for implementing an academia industry interface framework is provided. The academia industry interface system may be configured to implement the academia industry interface framework based on collaboration instructions. The collaboration instructions may further be categorized into collaboration parameters. In one implementation, the collaboration parameters may include, but are not limited to communication parameters, leadership influence parameters, influencing curriculum parameters, faculty influence parameters, and student influence parameters. The collaboration parameters play a substantial role in ensuring an effective collaboration between academic institutions and industrial organizations from different fields. In one implementation, the academia industry interface framework may be referred to as CLIFS framework which is an acronym with first alphabet of the collaboration parameters put together.

Further, the academia industry interface system may implement the CLIFS framework in predefined sequential steps. The sequential steps may be defined in a manner to ensure maximum productivity and effective outcome from the collaboration between the academic institutions and the industrial organizations. In one implementation, the CLIFS framework may be implemented by addressing each of the collaboration parameters sequentially, i.e., each step following the progression in order from the communication parameters to the leadership influence parameters to the influencing curriculum parameters to the faculty influence parameters to the student influence parameters and again to the communication parameters. In said implementation, the collaboration parameters can be communicated in a progressive order beginning from the communication parameters through the leadership influence parameters, the influencing curriculum parameters, the faculty influence parameters, and the student influence parameters. Therefore, the system may be configured to implement CLIFS framework in sequential steps thereby, providing a structured approach for ensuring a productive collaboration between the academic institutions and the industrial organizations.

Continuing with the present implementation, the system receives collaboration instructions from the industrial organization. The collaboration instructions may concern requirements of the industrial organization, so that the students studying in the academic institution may be trained to work in the concerned industrial organization. For example, the collaboration instructions may concern schedule of meetings between industrial organization representatives and administrative personnel of the academic institution, information to be circulated to different sections of the academic institutions, arrangement of training session for the students, etc. Further, the system may be configured to define the collaboration instructions in form of at least one of the collaboration parameters, i.e., the communication parameters, the leadership influence parameters, the influencing curriculum parameters, the faculty influence parameters, and the student influence parameters. For example, when the collaboration instructions concern information to be conveyed to the administrative personnel, the instruction may be defined in form of the leadership influence parameters. Similarly, collaboration instructions that concerns schedule for delivering the information may be defined in form of the communication parameters. Therefore, as would be understood, the collaboration instructions may be defined in form of the collaboration parameters based on content of the collaboration instructions.

The CLIFS framework may facilitate a consistent and continuous communication between the industrial organization and the academic institution. In an implementation, once the collaboration parameters are defined based on the collaboration instructions received, the system may initiate relevant activities in the academic institution based on the communication parameters. As would be understood, communication may act as a relevant component for ascertaining a productive collaboration between the academic institutions and the industrial organizations. The system starts with, ends with, and ensures a consistent and continuous communication between the academic institutions and the industrial organizations. In another implementation, the industrial organizations may maintain stratified levels of communication with different sections of the academic institution, such as faculty, students, and administrative personnel. For example, information that needs to be conveyed to the administrative personnel may be different from information to be conveyed to the students or the faculty. Therefore, when required, details of interaction of the industrial organizations with the administrative personnel may not be considered appropriate for disclosing to the students or the faculty. In one implementation, a unique access code may be provided to a concerned person, such as a student, faculty, and Dean to access a specific set of information, thereby blocking others from accessing the information. Therefore, the CLIFS framework facilitates the industrial organization to maintain stratified levels of communication with the different sections of the academic institutions and therefore, ensures confidentiality and secure access of information.

In a further implementation, the system may allow the industrial organization to establish communication with the different sections of the academic institutions through social media, such as social networking sites, social network closed groups, newsletters (digital as well as hard copies), newspapers, and television. In other implementations, information about developments concerning the industrial organizations may be communicated through a communication channel can include one or more of electronic mail (e-mail), blogs, television, social media, and Short Message Service, seminars, web-based seminars, web-based interactive sessions, audio conferencing, pop-up advertising, video conferencing, and communication through hard copies, say newspaper, pamphlets, brochures and periodical letters.

Further, the system may allow the industrial organization to arrange sessions and seminars through face to face interactions or video conferences for the students and the faculty, to address their queries and informing them about the industrial organization's requirements, industry trends, technology developments and career opportunities. Furthermore, if required, such sessions may be arranged for the students, the faculty, and the Dean, separately.

In one implementation, the industrial organizations may participate in academic and business events, such as college festival and symposiums to make the academic institutions familiar with their industrial organization. As would be gathered, the system ensures that the communication remains contextual, consistent and continuous through the collaboration between the academic institutions and the industrial organizations, thereby negating possibilities of miscommunication or any communication gap.

In one implementation, the CLIFS framework may facilitate the industrial organization to update the administrative personnel of the academic institution by informing them about developments of the industrial organization based on a predefined schedule. Therefore, once ensuring consistent communication, the system may proceed to the next step by executing relevant activities based on the leadership influence parameters. As may be understood, the Deans or the Principals or other administrative personnel may be authorized to take decisions concerning involvement of the industrial organizations in their academic institutions. For driving such academia industry interface system effectively in an academic institution, it is relevant to take the leaders of the academic institution, e.g., administrative personnel, in confidence, before proceeding for any interaction with the faculty or the students. Therefore, the industrial organizations tend to communicate with the administrative personnel, such as Vice chancellors, Dean and Principal regularly, to keep them updated and well informed about developments concerning the industrial organization. Since the administrative personnel of the academic institutions are well informed about the industrial organization, the administrative personnel may subsequently motivate institution fraternity to work towards establishing a productive and beneficial relationship with the industrial organization. In one implementation, the CLIFS framework may facilitate monthly or quarterly or yearly meetings between the administrative personnel of academic institutions and the representatives of the industrial organizations to discuss the recent developments and future plans concerning the collaboration.

The CLIFS framework may also facilitate the industrial organization and the academic institutions to introduce change(s) in an existing curriculum to include content as per requirement of the industry trends and technological advances. Subsequently, the system may proceed to the next step by initiating relevant activities based on the influencing curriculum parameters. Generally, knowledge gained by students while studying in the academic institutions may be different than current requirement of the industrial organizations. The students may gain text book knowledge of a subject, but the practical implementation of the knowledge in an industrial environment may pose difficulties. In that situation, the industrial organizations may conduct a training course for new employees, so that the new employees may be trained as per the requirements of the industrial organization. The industrial organization may have to invest their significant resources and time to train the new employees.

As mentioned previously, the CLIFS framework facilitates the academic institutions to modify the curriculum as per the requirements of the industrial organizations, thereby minimizing efforts of the industrial organization for in-house training of the students. Therefore, if the knowledge required for working in the industrial organization is not available in the existing curriculum of the academic institutions, the curriculum may be changed to address the industrial organization's needs. In one implementation, different sets of curriculum may be designed to address the requirements of industrial organizations from different fields. For example, the curriculum designed for a civil industry may be different from the curriculum designed for a chemical industry. In another implementation, curriculum may be different for different industrial organizations of same field. In yet another implementation, there are multi domain industrial organizations which expect new employees to be skilled in multiple fields. Accordingly, the curriculum may be designed to train the students for multi domain industrial organization.

Therefore, the system allows the students to opt for a curriculum based on a preference chosen by the students. For example, if a student wants to join a chemical based industry, the student may select the curriculum designed as per the chemical industry's requirements. In yet another implementation, guest lectures may be organized to educate the students about the knowledge required for working in an industrial organization. Furthermore, representatives of different industrial organizations may be a member of an academy advisory committee of the academic institutions and therefore, may provide inputs to shape and influence the curriculum as per the industry trends and requirements of the industrial organization.

As would be understood, the students spend a significant amount of time with the faculty. Further, the students prefer consulting their faculty for advice and queries concerning their career. Therefore, the faculty may be key influencers in guiding the students to make right choices in their career. Therefore, it is relevant that the faculty understands the industrial organization well. Any misguided information will lead to inadvertent loss to the industrial organization as the students may not get motivation and guidance to join the industrial organization.

The CLIFS framework may facilitate the industrial organization to train and inform the faculty about the industrial organization so that they can encourage the students to make a well informed decision to join the industrial organization. Subsequently, the system may proceed to the next step by initiating relevant activities based on the faculty influence parameters. In one implementation, the system may be configured to arrange sessions for the faculty to be conducted by the industrial organization to make the faculty familiar with the industrial organization. In such sessions, the faculty may be informed about the requirements of the industrial organization and the industry trends. The faculty may also be informed about working culture of the industrial organization. In one implementation, industry visits may be arranged for the faculty so that they can know about the working culture and the environment of the industrial organization. Therefore, once knowing about the industrial organization, the faculty may encourage the students for joining the industrial organization.

Furthermore, the faculty may have a key role in designing the curriculum for the students. Generally, suggestions provided by the faculty regarding the curriculum are considered relevant. Therefore, the faculty may play a significant role in incorporating important topics in the curriculum as per the requirements of the industrial organization. Therefore, the system ensures that the faculty is well informed about the industrial organization so that the faculty may motivate the students for joining the industrial organization.

The CLIFS framework may also facilitate the students to be well informed and aware about the industrial organization and the requirements of the industrial organization. Therefore, the system may proceed to the next step by initiating relevant activities based on the student influence parameters. It is substantially relevant to address concerns of the students and help them understand career opportunities and benefits of joining the concerned industrial organization. The system may be configured to assist the students to be prepared for industry specific jobs after their studies.

The previously mentioned steps ensure that the students stay updated and aware about the developments and opportunities concerning the industrial organizations. In one implementation, the system may be configured to arrange campus awareness programs. In another implementation, the industrial organization may arrange competitive events for the students to be conducted by experts from the industrial organization. They benefit from other inputs like courses designed, guest lectures, awareness sessions on industry and opportunities provided by the system.

For the collaboration parameters, the system provides illustrative engagement programs and initiatives as per the requirements of the industrial organization. During implementation of the CLIFS framework offered by the system, the industrial organizations may select the collaboration parameters for efficient and optimally productive interaction with the academic institutions.

As would be gathered, implementation of the CLIFS framework by the system assists the industrial organizations in human resource development thereby providing human resources skilled as per the requirements of the concerned industrial organizations. Further, the CLIFS framework facilitates the academic institution with better placement of the students and therefore establishing a prominent stature of the academic institution in the academic world.

These and other advantages of the present subject matter would be described in greater detail in conjunction with the following figures. While aspects of described system(s) and method(s) for implementing an academia industry interface framework can be implemented in any number of different computing systems, environments, and/or configurations, the embodiments are described in the context of the following exemplary system(s).

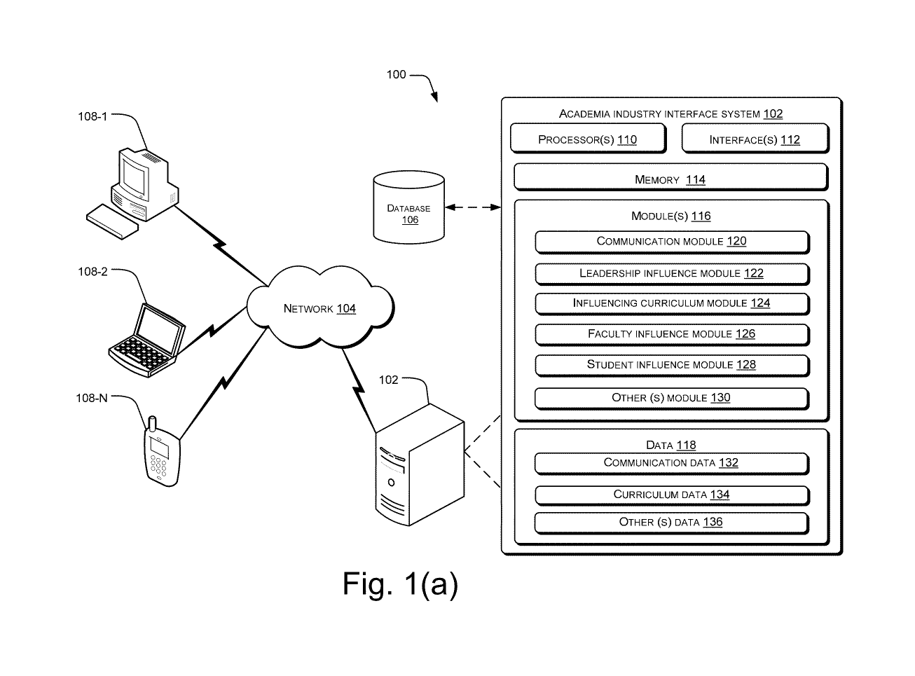

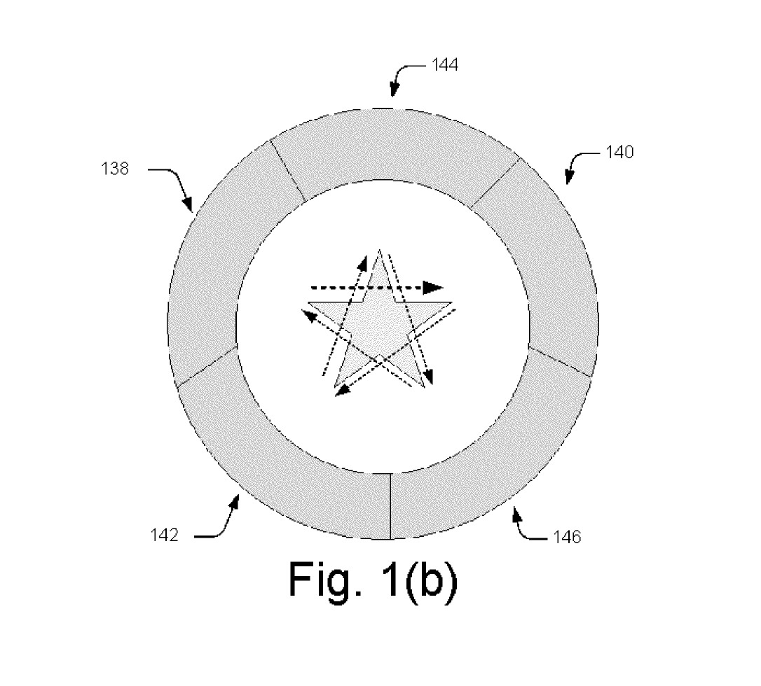

FIG. 1(a) illustrates a network environment 100 implementing an academia industry interface system 102 (hereinafter referred to as, system 102), according to an embodiment of the present subject matter. In the network environment 100, the system 102 is connected to a network 104. Further, the system 102 is connected to a database 106. Additionally, the network environment 100 includes one or more client devices 108-1, 108-2 . . . 108-N, collectively referred to as client devices 108 and individually referred to as client device 108, connected to the network 104. In one implementation, the client device 108 may be used to run registered processes that are monitored by the system 102. In another implementation, the client device 108 may be used to view the logs pertaining to the execution of the registered processes. In yet another implementation, the client device 108 may be used for both purposes.

The system 102 can be implemented as any set of computing devices connected to the network 104. For instance, the system 102 may be implemented as workstations, personal computers, desktop computers, multiprocessor systems, laptops, network computers, minicomputers, servers, and the like. In addition, the system 102 may include multiple servers to perform mirrored tasks for users.

Furthermore, the system 102 can be connected to the client devices 108 through the network 104. Examples of the client devices 108 include, but are not limited to personal computers, desktop computers, smart phones, PDAs, and laptops. Communication links between the client devices 108 and the system 102 are enabled through various forms of connections, for example, via dial-up modem connections, cable links, digital subscriber lines (DSL), wireless or satellite links, or any other suitable form of communication.

Moreover, the network 104 may be a wireless network, a wired network, or a combination thereof. The network 104 can also be an individual network or a collection of many such individual networks interconnected with each other and functioning as a single large network, e.g., the internet or an intranet. The network 104 can be implemented as one of the different types of networks, such as intranet, local area network (LAN), wide area network (WAN), the internet, and such. The network 104 may either be a dedicated network or a shared network, which represents an association of the different types of networks that use a variety of protocols, for example, Hypertext Transfer Protocol (HTTP), Transmission Control Protocol/Internet Protocol (TCP/IP), etc., to communicate with each other. Further, the network 104 may include network devices, such as network switches, hubs, routers, host bus adapters (HBAs), for providing a link between the system 102 and the client devices 108. The network devices within the network 104 may interact with the system 102 and the client devices 108 through communication links.

In said embodiment, the system 102 includes one or more processor(s) 110, interface(s) 112, and a memory 114 coupled to the processor 110. The processor 110 can be a single processing unit or a number of units, all of which could also include multiple computing units. The processor 110 may be implemented as one or more microprocessors, microcomputers, microcontrollers, digital signal processors, central processing units, state machines, logic circuitries, and/or any devices that manipulate signals based on operational instructions. Among other capabilities, the processor 110 is configured to fetch and execute computer-readable instructions and data stored in the memory 114.

The interfaces 112 may include a variety of software and hardware interfaces, for example, interface for peripheral device(s), such as a keyboard, a mouse, an external memory, and a printer. Further, the interfaces 112 may enable the system 102 to communicate with other computing devices, such as web servers and external data repositories, such as the database 106, in the network environment 100. The interfaces 112 may facilitate multiple communications within a wide variety of protocols and networks, such as a network, including wired networks, e.g., LAN, cable, etc., and wireless networks, e.g., WLAN, cellular, satellite, etc. The interfaces 112 may include one or more ports for connecting the system 102 to a number of computing devices.

The memory 114 may include any non-transitory computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The non-transitory computer-readable medium, however, excludes a transitory, propagating signal. The memory 114 also includes module(s) 116 and data 118.

The module(s) 116 include routines, programs, objects, components, data structures, etc., which perform particular tasks or implement particular abstract data types. In one implementation, the module(s) 116 includes a communication module 120, a leadership influence module 122, an influencing curriculum module 124, a faculty influence module 126, a student influence module 128, and other module(s) 130. The other module(s) 130 may include programs or coded instructions that supplement applications and functions of the system 102.

On the other hand, the data 118, inter alia serves as a repository for storing data processed, received, and generated by one or more of the module(s) 116. The data 118 includes, for example, a communication data 132, a curriculum data 134, and other data 136. The other data 136 includes data generated as a result of the execution of one or more modules in the module(s) 116.

In one implementation, the system 102 may be configured to implement the academia industry interface framework. In one implementation, the communication module 120 may be configured to receive collaboration instructions from an industrial organization. Generally, the industrial organizations maintain stratified levels of communication with different sections of an academic institution. For example, the industrial organization may want to communicate some information to the faculty once a week for 3 months, whereas some other information may be delivered to Dean once a quarter for a year. In one implementation, the different sections of the academic institution may include, but are not limited to administrative personnel, faculty, and students.

In one implementation, the communication module 120 may be configured to define the collaboration instructions in form of collaboration parameters. In one implementation, the collaboration parameters may include, but are not limited to communication parameters, leadership influence parameters, influencing curriculum parameters, faculty influence parameters, and student influence parameters. The parameters may be defined based on content of the collaboration instructions. For example, if the collaboration instructions relate to schedule for communicating with different sections of the academic institution, such as administrative personnel, faculty, and Dean, the communication module 120 may define the collaboration instructions in form of the communication parameters. Similarly, when the collaboration instructions concern curriculum of the academic institution, the communication module 120 may define the collaboration instructions in the form of the influencing curriculum parameters. Further, in one implementation, the academia industry interface framework may be referred to as CLIFS framework.

In another implementation, the leadership influence module 122 may be configured to manage the leadership influence parameters defined by the communication module 120. Further, the influencing curriculum module 124 may be configured to manage the influencing curriculum parameters. Furthermore, the faculty influence module 126 may manage the faculty influence parameters. Similarly, the student influence module 128 may be configured to manage the student influence parameters. The functionalities of the abovementioned modules are explained in detail later.

Continuing with the present implementation, the system 102 may implement the CLIFS framework in predefined sequential steps. In one implementation, the CLIFS framework may be implemented by addressing each of the collaboration parameters sequentially in each step following the progression in order of the communication parameters to the leadership influence parameters to the influencing curriculum parameters to the faculty influence parameters to the student influence parameters and again to the communication parameters. In said implementation, the collaboration parameters can be communicated in a progressive order beginning from the communication parameters through the leadership influence parameters, the influencing curriculum parameters, the faculty influence parameters, and the student influence parameters. Therefore, the CLIFS framework may be configured to work in sequential steps thereby providing a structured approach for ensuring a productive and effective collaboration between the academic institutions and the industrial organizations.

As mentioned previously, the communication module 120 may define collaboration instructions received from the industrial organization in form of at least one of the communication parameters, the leadership influence parameters, the influencing curriculum parameters, the faculty influence parameters, and the student influence parameters. In one implementation, the communication module 120 may be configured to manage the communication parameters. Further, the communication module 120 may be configured to determine the recipient of information based on the collaboration instructions received from the industrial organization. For example, the industrial organization may instruct the system 102 to provide information to the administrative personnel of the academic institution based on a predefined schedule. In such a situation, since the recipient of the information is the administrative personnel, the communication module 120 may define the leadership influence parameters for the instruction and forward it to the leadership influence module 122. However, the communication module 120 may define communication parameters pertaining to the predefined schedule for providing the information to the administrative personnel.

Further, the leadership influence module 122 may retrieve the information A from the database 106 or the external data repository and forward it to the administrative personnel. Furthermore, the communication module 120 may be configured to ensure that the leadership influence module 122 forwards the information to the administrative personnel in compliance with the communication parameters. In one implementation, the communication module 120 may provide a notification to the leadership influence module 122, wherein the notification may be based on the communication parameters. Therefore, leadership influence module 122 may be configured to design a program for communication between the industrial organization and the administrative personnel of the academic institution based on the leadership influence parameters and the notification received from the communication module. As would be appreciated by a person skilled in the art, in the present implementation, the communication module 120 and the leadership influence module 122 may work in conjunction with each other to ensure that the information is provided to the administrative personnel based on the predefined schedule.

In another implementation, the information provided to the administrative personnel by the leadership influence module 122 may include, but is not limited to updates about developments in the industrial organization, notifications about business and academic events, and notifications for meetings between representatives of the industrial organization and the administrative personnel of the academic institution.

In a further implementation, the leadership influence module 122 may be configured to forward the information to the administrative personnel through social media, such as social networking sites, blogs, newspapers, and television. In yet another implementation, the leadership influence module 122 may deliver the information through a communication channel can include one or more of electronic mail (e-mail), blogs, television, social media, and Short Message Service, seminars, web-based seminars, web-based interactive sessions, audio conferencing, pop-up advertising, video conferencing, and communication through hard copies, say newspaper, pamphlets, brochures and periodical letters.

In one example, the communication module 120 may be configured to store information concerning the communication parameters in the communication data 132. In another example, the leadership influence module 122 may be configured to store information concerning the leadership influence parameters in the communication data 132.

Therefore, the CLIFS framework ensures that the administrative personnel of the academic institutions are kept well informed about the industrial organization so that the administrative personnel may subsequently motivate institution fraternity to work towards establishing a productive and beneficial relationship with the industrial organization.

As mentioned earlier, knowledge gained by students while studying in the academic institutions may be different than requirement of the industrial organizations. Therefore, the industrial organizations may provide collaboration instructions pertaining to change in curriculum of the academic institutions, so that the curriculum may conform to the requirements of the industrial organization. In one implementation, when the communication module 120 receives collaboration instructions pertaining to curriculum of the academic institution, the communication module 120 define the influencing curriculum parameters and forward the influencing curriculum parameters to the influencing curriculum module 124.

In one implementation, the influencing curriculum module 124 may maintain an existing curriculum. Further, the influencing curriculum module 124 may receive the collaboration instructions pertaining to the curriculum in form of the influencing curriculum parameters. Based on the influencing curriculum parameters, the influencing curriculum module 124 may be configured to forward information pertaining to the collaboration instructions to an academy advisory committee of the academic institution. In one implementation, the information may include, but is not limited to topics to be included in an existing curriculum as per requirements of the industrial organization, topics to be removed from the existing curriculum, and a new curriculum to be implemented in the academic institution as per the requirements of the industrial organization.

In one implementation, the communication module 120 may provide a notification to the influencing curriculum module 124, wherein the notification may be based on the communication parameters. Therefore, in one implementation, the communication module 120 and the influencing curriculum module 124 may work in conjunction with each other. Further, the academy advisory committee may approve changes suggested by the industrial organization. Subsequently, the influencing curriculum module 124 may modify the existing curriculum based on the changes approved by the academy advisory committee. The influencing curriculum module 124 may further be configured to maintain the modified curriculum. Further, as may be understood, different industrial organizations may suggest different changes in the existing curriculum. For example, the curriculum designed for a civil industry may be different from the curriculum designed for a chemical industry. In another implementation, curriculum may be different for different industrial organizations of same field. Therefore, the influencing curriculum module 124 may be configured to design and maintain multiple curriculums based on requirements of the industrial organizations from different field.

In one implementation, the influencing curriculum module 124 may receive requests from the students to select one of the multiple curriculums based on their personal preference. For example, if a student wants to join a civil industry, the student may select the curriculum designed as per requirements of the civil industry. Therefore, the influencing curriculum module 124 may be configured to deliver the curriculum based on the selection of the students. Further, a student may opt for a specialized course relating to a specific field for a short period of time.

In another implementation, the influencing curriculum module 124 may be configured to forward the information to concerned recipient through social media, such as social networking sites, newspapers, blogs, and television. In a further implementation, the influencing curriculum module 124 may deliver the information through a communication channel can include one or more of electronic mail (e-mail), blogs, television, social media, and Short Message Service, seminars, web-based seminars, web-based interactive sessions, audio conferencing, pop-up advertising, video conferencing, and communication through hard copies, say newspaper, pamphlets, brochures and periodical letters. Further, in one example, the influencing curriculum module 124 may be configured to store information concerning the influencing curriculum parameters in the curriculum data 134.

Once the curriculum is selected by the students of the academic institutions, the faculty influence module 126 may be configured to manage the faculty influence parameters. Since the students spend a significant amount of time with the faculty, the industrial organizations ensures that the faculty understands the industrial organization and the modified curriculum designed as per the requirements of the industrial organization.

Further, as described earlier, the faculty may be key influencers in guiding the students to make right choices in their career. Therefore, the system 102 ensures that the faculty understands the industrial organization well so that the faculty can encourage the students to join the industrial organization. In one implementation, the communication module 120 may define the faculty influence parameters associated with the collaboration instructions of the industrial organization and forward the faculty influence parameters to the faculty influence module 126. Further, there may be communication parameters associated with the collaboration instructions. As mentioned earlier, the communication module 120 may be configured to manage the communication parameters.

Continuing with the present implementation, the faculty influence module 126 may retrieve information pertaining to the faculty influence parameters from the database 106 or the external data repository. In one implementation, the information may include, but is not limited to updates about developments of the industrial organization and industry trends, sessions for interaction of the faculty with the industrial organization, industrial visits for the faculty, and tips to the faculty for teaching the modified curriculum to the students effectively. Further, the faculty influence module 126 may be configured to deliver the information to the faculty based on a predefined schedule. In one implementation, compliance to the schedule for sending the information to the faculty may be ensured by the communication module 120. In one implementation, the communication module 120 may provide a notification to the faculty influence module 126, wherein the notification may be based on the communication parameters. Therefore, the faculty influence module 126 may be configured to design a program for communication between the industrial organization and the faculty of the academic institution based on the faculty influence parameters and the notification received from the communication module 120. As would be appreciated by a person skilled in the art, in the present implementation, the communication module 120 and the faculty influence module 126 may work in conjunction with each other.

In a further implementation, the faculty influence module 126 may be configured to forward the information to the faculty through social media, such as social networking sites, newspapers, and television. In other implementations, the faculty influence module 126 may deliver the information through a communication channel can include one or more of electronic mail (e-mail), blogs, television, social media, and Short Message Service, seminars, web-based seminars, web-based interactive sessions, audio conferencing, pop-up advertising, video conferencing, and communication through hard copies, say newspaper, pamphlets, brochures and periodical letters. Further, in one example, the faculty influence module 126 may be configured to store information concerning the faculty influence parameters in the communication data 132.

Further, as may be understood, it is substantially relevant to address concerns of the students and help them understand career opportunities and benefits of joining the concerned industrial organization. Therefore, the communication module 120 may receive collaboration instructions from the industrial organization targeting the students. The communication module 120 may define the student influence parameters for collaboration instructions targeting the students.

Further, the communication module 120 may be configured to forward the student influence parameters to the student influence module 128. In one implementation, the student influence module 128 may be configured to retrieve information based on the collaboration instructions from the database 106 or the external data repository. In one implementation, the information may include, but is not limited to notifications about campus awareness programs, competitive events, updates about developments of the industrial organization, and sessions for interaction of the students with the industrial organization.

In another implementation, the communication module 120 may manage the communication parameters associated with the collaboration instructions targeting the students. In one implementation, the communication module 120 may provide a notification to the student influence module 128, wherein the notification may be based on the communication parameters. Therefore, the student influence module 128 may be configured to design a program for communication between the industrial organization and students of the academic institution based on the student influence parameters and the notification received from the communication module 120.As would be appreciated by a person skilled in the art, in the present implementation, the communication module 120 and the student influence module 128 may work in conjunction with each other to ensure that the information is provided to the students based on a predefined schedule.

In a further implementation, the student influence module 128 may be configured to forward the information to the students through social media, such as social networking sites, newspapers, blogs, and television. In other implementations, the student influence module 128 may deliver the information through a communication channel can include one or more of electronic mail (e-mail), blogs, television, social media, and Short Message Service, seminars, web-based seminars, web-based interactive sessions, audio conferencing, pop-up advertising, video conferencing, and communication through hard copies, say newspaper, pamphlets, brochures and periodical letters. Further, in one example, the student influence module 128 may be configured to store information concerning the student influence parameters in the communication data 132.

FIG. 1(b) illustrates a representation of an academia industry interface framework implemented by an academia industry interface system 102, according to one embodiment of the present subject matter. Further, the representation is provided for a better clarity of the subject matter and should not be considered as limiting and the academia industry interface framework may be represented using various other forms of representation as would be appreciated by a person skilled in the art. As mentioned in the description of FIG. 1(a), the academia industry interface framework may categorize the collaboration instructions in collaboration parameters. In one implementation, the collaboration parameters may include, but are not limited to communication parameters 138, leadership influence parameters 140, influencing curriculum parameters 142, faculty influence parameters 144, and student influence parameters 146. In one implementation, the academia industry interface framework may be referred to as CLIFS framework.

Further, CLIFS framework may work in predefined sequential steps. In one implementation, the CLIFS framework may be implemented by addressing each of the collaboration parameters sequentially in each step following the progression in order of the communication parameters 138 to the leadership influence parameters 140 to the influencing curriculum parameters 142 to the faculty influence parameters 144 to the student influence parameters 146 and again to the communication parameters 138.

Further, as shown in the FIG. 1(b), the collaboration parameters, i.e., the communication parameters 138, the leadership influence parameters 140, the influencing curriculum parameters 142, the faculty influence parameters 144, and the student influence parameters 146 may be depicted as different nodes of a star. Therefore, in one implementation, the CLIFS framework may be referred to as CLIFS-STAR framework. Further, the arrows shown in FIG. 1(b) are representative of a sequence in which the various parameters in the framework are encountered, according to the foregoing embodiment. Further, in other implementations, the collaboration parameters may be represented in form of various shapes, such as a pentagon (not shown).

As would be understood, communication may act as a relevant component for ascertaining a productive collaboration between the academic institutions and the industrial organizations. Therefore, the CLIFS framework starts with, ends with, and ensures a consistent and continuous communication between the academic institutions and the industrial organizations.

In one implementation, once ensuring consistent communication, the CLIFS framework may proceed to the next step by executing relevant activities based on the leadership influence parameters 140. For example, in one implementation, the CLIFS framework may facilitate meetings between the administrative personnel of academic institutions and the representatives of the industrial organizations concerning the collaboration.

Subsequently, as mentioned earlier, the CLIFS framework may facilitate the industrial organization and the academic institutions to design a curriculum as per the requirements of the industrial organization by initiating relevant activities based on the influencing curriculum parameters 142.

Following the progression, the CLIFS framework may address the faculty influence parameters 144 and facilitate the industrial organization to train and inform the faculty about the industrial organization so that they can encourage the students to join the industrial organization. For example, the CLIFS framework may facilitate sessions for the faculty to be conducted by the industrial organization.

As would be appreciated by a person skilled in the art, it is substantially relevant to address concerns of the students and help them understand career opportunities and benefits of joining the concerned industrial organization. Therefore, the CLIFS framework may facilitate the students to be well informed and aware about the industrial organization and the requirements of the industrial organization by addressing the student influence parameters 146.

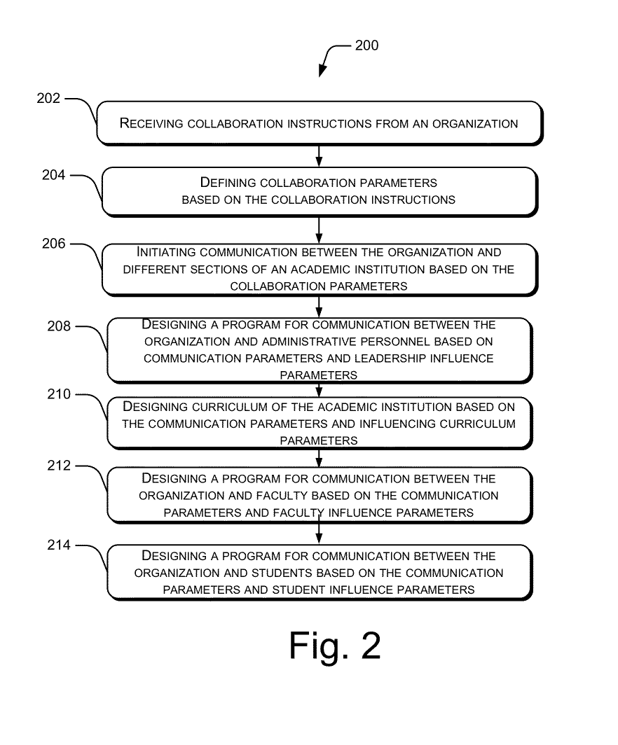

FIG. 2 illustrates a method 200 for implementing an academia industry interface framework, according to one embodiment of the present subject matter. The method 200 may be implemented in a variety of computing systems in several different ways. For example, the method 200, described herein, may be implemented using a system 102, as described above.

The method 200, completely or partially, may be described in the general context of computer executable instructions. Generally, computer executable instructions can include routines, programs, objects, components, data structures, procedures, modules, functions, etc., that perform particular functions or implement particular abstract data types. A person skilled in the art will readily recognize that steps of the method can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of the described method 200.

The order in which the method 200 is described is not intended to be construed as a limitation, and any number of the described method blocks can be combined in any order to implement the method, or an alternative method. Additionally, individual blocks may be deleted from the method without departing from the spirit and scope of the subject matter described herein. Furthermore, the methods can be implemented in any suitable hardware, software, firmware, or combination thereof. It will be understood that even though the method 200 is described with reference to the system 102, the description may be extended to other systems as well.

As may be understood, industrial organizations from different fields rely on academic institutions for talented and skilled human resources. On the other hand, the academic institutions rely on the industrial organizations for ensuring better placement of students studying in the academic institutions to achieve a prominent stature in the academic realm. Therefore, the academic institutions and the industrial organizations from different fields collaborate with each other. The system 102 implementing the academia industry interface framework, also referred to as CLIFS framework, ensures an effective and productive collaboration of the academic institutions and the industrial organizations.

At block 202, collaboration instructions from the industrial organization may be received. Through the collaboration instructions, the industrial organization may maintain different levels of communication with different sections of the academic institution. In one implementation, the different sections of the academic institution may include but not limited to administrative personnel, faculty, and the students. In an example, a communication module 120 of the system 102 may be configured to receive the collaboration instructions from the industrial organization.

At block 204, the collaboration instructions are defined in form of collaboration parameters. In one implementation, the collaboration parameters may include, but are not limited to communication parameters, leadership influence parameters, influencing curriculum parameters, faculty influence parameters, and student influence parameters. The collaboration parameters may be defined based on content of the collaboration instructions. For example, if the collaboration instructions relate to schedule for communication with the different sections of the academic institution, such as administrative personnel, faculty, and Dean, the system 102 may define the collaboration instructions in form of the communication parameters. Similarly, when the collaboration instructions concern curriculum of the academic institution, the system 102 may define the collaboration instructions in the form of the influencing curriculum parameters. In an example, the communication module 120 of the system 102 may be configured to define the collaboration instructions in form of the collaboration parameters.

After defining the instructions at the block 204, communication with intended recipient of the collaboration instructions may be initiated at block 206. For example, information pertaining to the leadership influence parameters may be forwarded to the administrative personnel based on a predefined schedule. Similarly, information pertaining to the influencing curriculum parameters may be forwarded to an academy advisory committee based on a predefined schedule. In one implementation, the information may include but not limited to updates about developments of the industrial organization, sessions for interaction of the faculty and the students with the industrial organization, suggestions for change in the curriculum, notifications about campus awareness programs, competitive events, industrial visits for the faculty and the students, and tips to the faculty for teaching modified curriculum to the students effectively.

In a further implementation, the information may be forwarded to the intended recipients through social media, such as social networking sites, newspapers and television. In other implementations, the information through may be delivered through a communication channel can include one or more of electronic mail (e-mail), blogs, television, social media, and Short Message Service, seminars, web-based seminars, web-based interactive sessions, audio conferencing, pop-up advertising, video conferencing, and communication through hard copies, say newspaper, pamphlets, brochures and periodical letters. In an example, the communication module 120 of the system 102 may be configured to forward information pertaining to the collaboration parameters to the intended recipients of the collaboration instructions.

At block 208, a program for communication between the industrial organization and administrative personnel of the academic institution is designed based on the leadership influence parameters and the communication parameters. Information pertaining to the leadership influence parameters may be forwarded to the administrative personnel based on the collaboration instructions. As described earlier, the information may include but not limited to updates about developments in the industrial organization, notifications about business and academic event, and notifications for meetings between representatives of the industrial organization and the administrative personnel of the academic institution. Further the information may be forwarded in compliance with the communication parameters associated with the collaboration instructions. In an example, the communication module 120 and the leadership influence module 122 of the system 102 may be configured to work in conjunction with each other to forward the information pertaining to the leadership influence parameters to the administrative personnel in compliance with a predefined schedule.

At block 210, curriculum for the academic institution may be designed based on the requirements of the industrial organization. In one implementation, information pertaining to the influencing curriculum parameters may be forwarded to the academy advisory committee based on the collaboration instructions. The information may include, but is not limited to topics to be included in an existing curriculum as per requirements of the industrial organization, topics to be removed from the existing curriculum, and a new curriculum to be implemented in the academic institution as per the requirements of the industrial organization. Further, the information may be forwarded in compliance with the communication parameters associated with the collaboration instructions. In an implementation, the students are allowed to select the curriculum based on their personal preference. For example, if a student wants to join an aeronautical industrial organization, the student may select curriculum designed as per the requirements of the aeronautical industrial organization. In an example, the communication module 120 and the influencing curriculum module 124 of the system 102 may be configured to work in conjunction with each other to forward the information pertaining to the influencing curriculum parameters to the academy advisory committee in compliance with a predefined schedule.

At block 212, a program for communication between the industrial organization and faculty of the academic institution may be designed based on the faculty influence parameters and the communication parameters. In one implementation, interactive sessions for the faculty may be arranged based on the requirements of the industrial organization Information pertaining to the faculty influence parameters may be forwarded to the faculty based on the collaboration instructions. The information may include, but is not limited to updates about developments of the industrial organization, industrial visits for the faculty, and tips to the faculty for teaching the modified curriculum to the students effectively. Further, the information may be forwarded in compliance with the communication parameters associated with the collaboration instructions. In an example, the communication module 120 and the faculty influence module 126 of the system 102 may be configured to work in conjunction with each other to forward the information pertaining to the faculty influence parameters to the faculty in compliance with a predefined schedule.

At block 214, a program for communication between the industrial organization and students of the academic institution may be designed based on the student influence parameters and the communication parameters. In one implementation, information pertaining to the student influence parameters may be forwarded to the students based on the collaboration instructions. As described earlier, the information may include, but is not limited to updates about developments of the industrial organization, industrial visits for the students, campus awareness programs, and notifications of competitive events. Further, the information may be forwarded in compliance with the communication parameters associated with the collaboration instructions. In an example, the communication module 120 and the student influence module 128 of the system 102 may be configured to work in conjunction with each other to forward the information pertaining to the student influence parameters to the students in compliance with a predefined schedule.

As understood from the foregoing description of FIG. 2, in said implementation, the method 200 includes that the collaboration parameters can be communicated in a progressive order beginning from the communication parameters through the leadership influence parameters, the influencing curriculum parameters, the faculty influence parameters, and the student influence parameters.

Although implementations of academia industry interface framework have been described in language specific to structural features and/or methods, it is to be understood that the present subject matter is not necessarily limited to the specific features or methods described. Rather, the specific features and methods are disclosed as implementations for the academia industry interface framework.

I/We claim:

1. A computer implemented method comprising:
receiving collaboration instructions from an industrial organization;
defining a plurality of collaboration parameters based on the collaboration instructions, wherein the plurality of the collaboration parameters comprises at least one of communication parameters, leadership influence parameters, influencing curriculum parameters, faculty influence parameters, and student influence parameters; and
initiating communication between the industrial organization and different sections of an academic institution in a predefined sequence based on the collaboration parameters.

2. The method as claimed in claim 1 further comprising designing a program for communication between the industrial organization and administrative personnel of the academic institution based on the leadership influence parameters and the communication parameters.

3. The method as claimed in claim 1 further comprising designing curriculum of the academic institution based on the influencing curriculum parameters and the communication parameters.

4. The method as claimed in claim 1 further comprising designing a program for communication between the industrial organization and faculty of the academic institution based on the faculty influence parameters and the communication parameters.

5. The method as claimed in claim 1 further comprising designing a program for communication between the industrial organization and students of the academic institution based on the student influence parameters and the communication parameters.

6. The method as claimed in claim 1, wherein the communication between the industrial organization and the different sections of the academic institution is performed through a communication channel comprising at least one of electronic mail (e-mail), blogs, television, social media, and Short Message Service, seminars, web-based seminars, web-based interactive sessions, audio conferencing, pop-up advertising, video conferencing, newspapers, pamphlets, brochures and periodical letters.

7. The method as claimed in claim 1, wherein the initiating communication in the predefined sequence comprises communicating the plurality of the collaboration parameters in a progressive order beginning from the communication parameters through the leadership influence parameters, the influencing curriculum parameters, the faculty influence parameters, and the student influence parameters.

8. An academia industry interface system for implementing an academia industry interface framework, the academia industry interface system comprising:
a processor; and
a communication module coupled to the processor, the communication module configured to:
receive collaboration instructions from an industrial organization;
defining a plurality of collaboration parameters based on the collaboration instructions, wherein the plurality of the collaboration parameters comprises at least one of communication parameters, leadership influence parameters, influencing curriculum parameters, faculty influence parameters, and student influence parameters; and
initiating communication between the industrial organization and different sections of an academic institution in a predefined sequence based on the collaboration parameters.

9. The academia industry interface system as claimed in claim 8 further comprising a leadership influence module configured to design a program for communication between the industrial organization and administrative personnel of the academic institution based on the leadership influence parameters and a notification received from the communication module, wherein the notification is received based on the communication parameters.

10. The academia industry interface system as claimed in claim 8 further comprising a influencing curriculum module configured to design a curriculum of the academic institution based on the influencing curriculum parameters and a notification received from the communication module, wherein the notification is received based on the communication parameters.

11. The academia industry interface system as claimed in claim 8 further comprising a faculty influence module configured to design a program for communication between the industrial organization and faculty of the academic institution based on the faculty influence parameters and a notification received from the communication module, wherein the notification is received based on the communication parameters.

12. The academia industry interface system as claimed in claim 8 further comprising a student influence module configured to design a program for communication between the industrial organization and students of the academic institution based on the student influence parameters and a notification received from the communication module, wherein the notification is received based on the communication parameters.

13. The academia industry interface system as claimed in claim 8, wherein the communication module is further configured to communicate the plurality of the collaboration parameters in a progressive order beginning from the communication parameters through the leadership influence parameters, the influencing curriculum parameters, the faculty influence parameters, and the student influence parameters.

14. A non-transitory computer-readable medium having embodied thereon a computer program for executing a method comprising:
receiving collaboration instructions from an industrial organization;
defining a plurality of collaboration parameters based on the collaboration instructions, wherein the plurality of the collaboration parameters comprises at least one of communication parameters, leadership influence parameters, influencing curriculum parameters, faculty influence parameters, and student influence parameters; and
initiating communication between the industrial organization and different sections of an academic institution in a predefined sequence based on the collaboration parameters.

15. The non-transitory computer-readable medium as claimed in claim 14, wherein the initiating the communication in the predefined sequence comprises communicating the plurality of the collaboration parameters in a progressive order beginning from the communication parameters through the leadership influence parameters, the influencing curriculum parameters, the faculty influence parameters, and the student influence parameters.
